(19) United States
(12) Patent Application Publication
(10) Pub. No.: US 2009/0055156 A1
(43) Pub. Date: Feb. 26, 2009

(54) USING COMMERCIAL COMPUTING PACKAGE MODELS TO GENERATE MOTOR CONTROL CODE

(75) Inventor: Mark R. Cooper, Eden Prairie, MN (US)

Correspondence Address: AMIN TUROCY & CALVIN, LLP;ATTENTION: HEATHER HOLMES, 127 Public Square, 57th Floor, Key Tower, Cleveland, OH, 44114, US

(73) Assignee: ROCKWELL AUTOMATION TECHNOLOGIES, INC., Mayfield Heights, OH (US)

(21) Appl. No.: 11/844,944

(22) Filed: Aug. 24, 2007

(51) Int. Cl. G06G 7/62; G06F 9/45

(52) U.S. Cl. 703/22; 703/13

(57) ABSTRACT

Systems and methods for designing and/or diagnosing industrial applications including the use of a simulation of hardware and/or software elements. A correlation component can assess the degree of accuracy with which the simulation represents the operation of the hardware counterparts. A customer assistance system and method whereby a customer can describe a desired industrial application and request a simulative evaluation of the performance of the proposed equipment and software, and receive purchase information, suggested solutions, and diagnostic insight.

### BACKGROUND

In today's global economy, where competition is fierce and unrelenting, companies can ill afford to spend capital in risky or unfruitful ventures. In virtually all aspects of most competitive companies have been forced to seek an optimum efficiency model—personnel, management, benefits, even research and development frequently must be reduced or eliminated altogether in order to compete with today's top firms.

In manufacturing and industrial sectors, this effect has made particular impact. Companies of the past could afford to build factories and plants with only a faint idea of how well they would operate, and with minimal insight into how the industry may change in the future. As the global economy has matured, companies and manufacturers have realized a competitive need to predict operation of a facility before incurring the high cost of production. Gratefully, computing hardware, software, and techniques have matured at an equally rapid rate, granting the possibility of simulation to achieve these goals. The power of computer aided simulations provides the ability to construct a virtual model of a system at a much lower cost than physically building the same system. Further, simulations enable alternative designs to be tested so as to arrive at an optimal solution before committing to actual construction.

An additional force of competition is that the cost of labor has reduced at all levels, from low-level labor to highly skilled positions such as computer programming and testing. This has led to an increase in the use of computing simulations, and a trend toward quantity of simulations and other algorithms rather than toward a simple, central, elegant approach which may require a lower number of more highly skilled programmers and powerful equipment.

Commercial computing packages offer immense power to create simulated designs. Many employ a graphical user interface which allows easy manipulation of elements into virtually any arrangement to suit the needs of the moment. However, with such power comes a tendency to place to great a focus on the power itself. Without careful and well thought plans and implementations commercial computing packages can deliver a false sense of confidence. Like any tool, there is potential for harm if not used properly.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure relates to systems and methods that facilitate simulation of an industrial process, enabling rapid, low cost design and virtual testing of new industrial processes. A simulation component, which can comprise a commercial computing package, can represent elements of an industrial process and their interaction. A correlation component can compare a simulation for each element or group of elements with the functionality of actual target hardware which the simulation represents in order to ensure the accuracy of the simulation. The correlation component can convey a degree of correlation between a piece of hardware and its simulative representation, which can depend on the implementation of the equipment, and also on other elements with which the simulated element interacts directly or indirectly. In this manner, a designer can focus design or diagnostic energy on a portion or aspect of the industrial process. In accordance with another embodiment, the simulation component can interact with certain elements that are actual hardware, and other elements that are purely simulated, mitigating the need to simulate all elements of the industrial process.

Another aspect of the subject disclosure permits the designer to generate motor control code for components of industrial equipment (e.g., hardware and/or software) used to control actual hardware. Commercially available computing packages are capable of generating this control code with minimal effort—some even with a mere few mouse-clicks or keystrokes. This can save much time and manpower that has previously been spent generating the motor control code. The use of the correlation component and other components of the subject system and methods provide a designer with confidence that the simulation is a true representation of the target hardware, and therefore code that is generated from the simulation will perform as desired.

In yet another embodiment, the simulation component can interface with a customer and receive a description of the customer's desired industrial process. The description can comprise a plurality of elements and sub-elements of the process to the level of granularity that the customer desires, and according to the particulars of the industrial process. The simulation component can perform a simulation of the proposed system and provide the customer with hardware purchasing options that can meet the customer's needs. In addition, the customer can use the system to diagnose a problem within an existing industrial process, and/or locate the source of the problem and determine other components that can meet the customer's needs in a more satisfactory manner.

In an embodiment, an artificial intelligence component can store information relating to past solutions and provide suggestions to a customer or a designer if a past solution has been used to solve a problem or arrangement similar to a current proposed solution. The artificial intelligence component can infer a likelihood or degree of similarity between a past solution and the present proposed solution. Additionally, the artificial intelligence component can assist the correlation component in determining the degree of correlation between a simulative representation of a piece of equipment and the actual equipment using artificial intelligence techniques.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates simulation of an industrial process, including a simulation component, a correlation component, and a code production component.

FIG. 2 is a block diagram showing further operation of the simulation component, including an artificial intelligence component.

FIG. 3 is a block diagram illustrating a simulation component, target hardware, and an actuator, depicting the interaction between simulated components and actual components, in accordance with an embodiment.

FIG. 4 is a block diagram rendering a simulation component and drive control code and actuator behavior code, within a simulated target hardware.

FIG. 5 is a block diagram depicting a customer design assistance system including an interface, a simulation component, and artificial intelligence component and an industrial application.

FIG. 6 is a block diagram rendering further detail of the industrial application.

FIG. 7 is a flow chart diagram depicting a methodology that allows a simulation of actual industrial elements to be compiled and run, and if necessary, diagnosed to ensure a proper correlation between the simulation and the actual hardware.

FIG. 8 is a flow chart diagram illustrating a methodology for using a correlated simulation to create new designs and arrangements for an industrial application.

FIG. 9 is a flow chart diagram describing a customer design and diagnosis methodology whereby a customer can receive insight into the operation of untested industrial elements to make an informed purchase or diagnostic decision relating to a given industrial application.

FIG. 10 is a flow chart diagram depicting a design and/or diagnostic assistance methodology including consulting a database for previous similar industrial situations and attempting to apply past solutions to present applications.

FIG. 11 is a schematic block diagram illustrating a suitable operating environment.

FIG. 12 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the term “component,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Examples are provided solely for purposes of clarity and understanding and are not meant to limit the subject innovation or relevant portion thereof in any manner. It is to be appreciated that a myriad of additional or alternate examples could have been presented, but have been omitted for purposes of brevity. Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g. compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

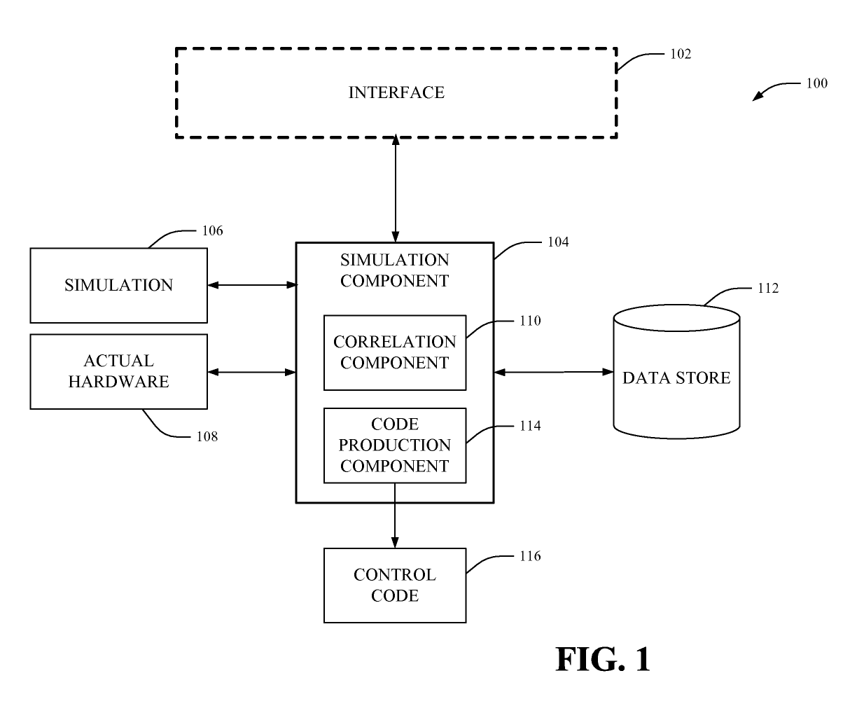

Referring now to the figures, FIG. 1 illustrates a system 100 that can simulate an industrial application, and employ the simulation in a variety of situations. Using the system 100, a designer can verify the viability of a design, and can cause the system 100 to replicate the entire application, or a subset of the elements thereof. With previous methods, the first step to creating an industrial application was to write software to control hardware that carries out the operations necessary to meet the company's needs. For example, hardware such as conveyors, mechanical arms, belts, and the like can be used to move a product from one stage of preparation to another and to act upon the product as needed. The process can continue until the product is completed and ultimately delivered. Throughout this process, the hardware performs physical acts, but is controlled by hardware, software, or some combination thereof. The software can be known as control logic, and writing control logic using conventional methods can be a difficult task yielding sometimes imperfect results. Also, writing control logic on actual hardware without experience with that hardware offers no assurance that the hardware can or will perform as desired. Further, actual hardware creation and deployment requires significant time and capital. The system 100 according to the subject disclosure can mitigate the risk and the guess-work involved with such an operation.

Interface 102 can facilitate interaction with the system 100, and can comprise a graphical interface, a command line interface, or any other suitable means of interacting with a computing system. In addition, interface 102 may also provide interaction between the system 100 and another non-human operator. Simulation component 104 can comprise any commercial simulation software product and allows a user to model elements of an industrial application. Some simulation components 104 provide an interface 102 that allows the user to create a block diagram, with different blocks representing different elements of the desired application. The different elements and their interconnections can be modeled as a network, and simulation component 104 can replicate the actual operation of the industrial process virtually. For example, a user may wish to know whether a given piece of equipment will overheat during operation. The simulation can enact the conditions under which the equipment will operate, and can provide an approximation of the temperature of the equipment under several different operation conditions. Much of the equipment used in industrial settings can interact with surrounding hardware via various inputs and outputs, which can also be modeled and simulated. According to one embodiment, the interface 102 is part of the simulation component 104, and can serve to facilitate simulation of the industrial application. In another embodiment, the interface 102 can be created separate from the simulation component 104.

A simulation 106 can mirror an actual application 108, and can include as much detail as required and at the discretion of the user who can create the simulation 106 by way of the interface 102 and the simulation component 104. Running the simulation gives the user some assurance that no problems will arise such as an overheat or a mechanical or electrical failure or the like. The industrial application can be performed, at least in part, on actual hardware 108 as well, to validate the accuracy of the simulation 106. Individual elements' stand-alone operation and/or the elements' interaction with other elements can be verified. A correlation component 110 can compare the operations of actual hardware 108 and the simulation 106 thereof, to ensure that the simulation 106 is an accurate representation. If there is not a positive correlation, the simulation can be modified and re-tested until the user is satisfied that the simulation 106 accurately represents the actual hardware 108 under various operating conditions.

In many cases, it is desirable to simulate only a subset of the elements of an industrial application. Many pieces of hardware have been used in previous applications, and their operation is therefore known. Additionally, some hardware can interact with a simulation directly by providing electronic communication to the simulation component 104 directly, mitigating the need to simulate that element. The system 100 can therefore include actual hardware and simulated hardware together to form a composite simulation. Such an arrangement can provide a favorable situation because the actual hardware 108 needs no correlation to a simulated counterpart, increasing the accuracy and reliability of the simulation 106. In addition, no effort is expended to create the simulation of the actual hardware 108.

Once there is an agreeable correlation between the actual hardware 108 and the simulation 106, the designer is assured that the simulation can be treated in virtually the same manner as the actual hardware 108. In an embodiment, the correlation component 110 can convey a correlation in terms of a percentage, or a position on a spectrum of correlation ranging from unrelated to exactly related. Due to the complexity of today's hardware used in the industrial setting, a tolerance for correlation can be specified by the user or by the system 100 to allow for degrees of mismatching between a simulation 106 and actual hardware 108. A designer may be concerned with certain variables more than others, and therefore can indicate that the correlation relating to those variable should be relatively high, where other variables may present a lower correlation value, but still fall within a tolerance.

The simulation component 104 can communicate with a data store 112 in order to store a simulation 106, or other supporting information. Past simulations can be stored and accessed in order to facilitate future simulations by reducing duplicative work if an element or component has been modeled in the past. The data store 112 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), magnetic drives, or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The data store of the present systems and methods is intended to comprise, without being limited to, these and any other suitable types of memory.

Knowing, to a satisfactory degree of certainty, that a simulation 106 represents the functioning of actual hardware 108 enables rapid, low cost, and reliable testing and modification of an industrial application. The user can experiment more freely with arrangements that pose a higher risk of failure without the associated high cost of experimenting in this manner with conventional systems. A skilled industrial engineer may encounter ideas from time to time that are new and untested, but that could result in enormous performance and/or throughput gains if successful. Using conventional systems, a prudent engineer would consider the risk of failure, coupled with the high cost of building an actual industrial plant, to be prohibitively expensive. The system 100 permits these type of cutting edge, unproven ideas to be tested without the substantial risk associated with building actual hardware and creating software for control. Moreover, once the correlation component 110 has reported that the simulation 106 represents the actual hardware 108 to a satisfactory level, the risk of pursuing a new idea becomes almost negligible. The company can obtain a reliable prediction of performance, provided by the simulation component 104 and the correlation component 110.

In accordance with another embodiment of the subject disclosure, simulation component 104 contains a code production component 114 that can generate control code 116 directly from a simulation 106. Many commercial software products (that can comprise the simulation component 104 in an embodiment) are capable of generating such code and can do so with minimal user effort. This control code 116 can be used directly to control the target hardware represented by the simulation 106 to perform the tasks for which the application was designed. Generating control code 116 in this manner reduces dramatically the time and manpower required to generate control code for industrial applications. In addition, control code generated for a specific piece of hardware can be stored in the data store 112 for use in future applications if they are sufficiently similar.

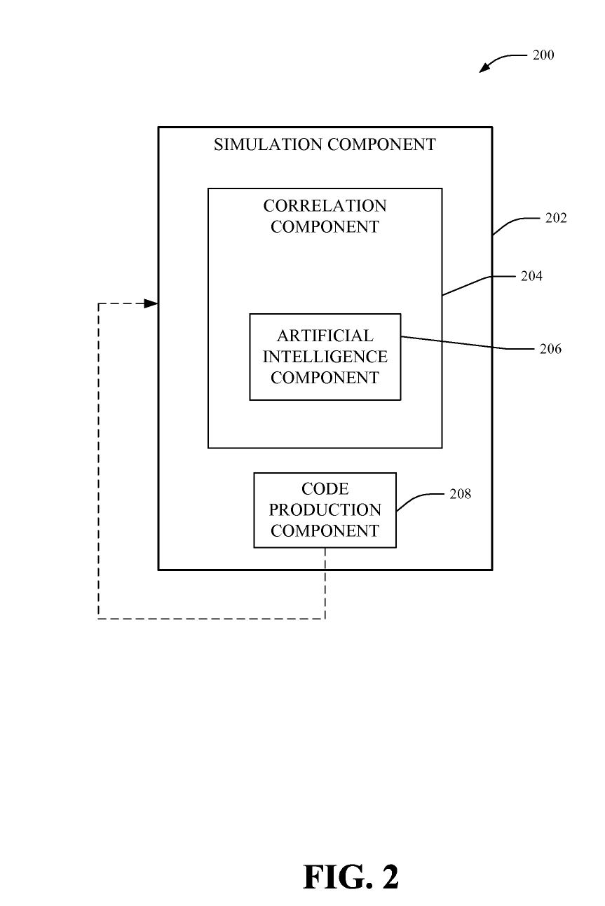

FIG. 2 depicts a system 200 illustrating further operation of the simulation component 202 and the correlation component 204. Correlation component 204 can compare the operation of actual hardware and a simulation thereof in order to verify that the simulation accurately represents the actual hardware. Correlation component 204 can also include an artificial intelligence component 206 that can assist with determining the accuracy of the simulation—how well the simulation correlates to the actual hardware. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Artificial intelligence component 206 can receive a proposed simulation of an application from a user, and can search past simulations for similar applications and/or simulations that are similar to a predetermined degree. Alternatively, the user can describe an industrial application, and the simulation component 202 can create the simulation to represent the application. If a satisfactorily similar simulation exists for a given piece of hardware or hardware configuration, the past simulation can be used in place of generating a new simulation. Furthermore, some hardware is updated by its manufacturer over time, resulting in a new version the hardware (e.g. a motor or a drive) that is substantially similar to previous equipment. The artificial intelligence component 206 can analyze the new hardware specifications and the differences between the previous version and the current version, and infer that the new hardware is substantially similar to a previous version of the same hardware. The user can be presented with this information and can then decide whether to accept the old simulation as it stands, update the simulation to reflect the changes in the hardware configuration, or to start from scratch and create a new simulation for the new hardware. By employing the artificial intelligence techniques described herein, the correlation component 204 can provide a highly detailed, accurate, and efficient correlation between hardware and its representing simulation, which in turn increases the user's ability to alter, rearrange, and modify the industrial application.

In another embodiment, code production component 208 can be used to generate motor control code from the simulation created by the simulation component 202. As described above, in an embodiment the simulation component 202 can comprise a commercial software package that has the ability to generate code that governs actual hardware directly from a simulation representing that hardware. The simulation component 202 and the code generation component 208 can work together to simplify the process of generating code, and reduce the amount of time and manpower required to produce such code.

A further embodiment of the present innovation can be to produce nested, or parent-child simulations. Code generation component 208 can generate code for a plurality of purposes, one of which is to create other simulations. As depicted, code produced by the code production component 208 can be fed back to the simulation component 202. The simulation thus produced can be used in the same manner as other simulations disclosed in the subject innovation. Nested simulations can comprise sub-simulations that form a portion of a larger simulation. Use of nested simulations allows a designer to focus on a specific sector of the industrial application without the computational and other costs of a larger system. Parent-child relationships provide an opportunity to pursue a hierarchical relationship between simulations. A child may not necessarily be used in an application related to the parent, but maintaining the relationship allows a designer to learn from both positive and negative experiences with the parent and apply the lessons to the children, or vice-versa. For example, if a given simulation is found to be a great success because of some characteristic or quality, its children may also exhibit the same desirable traits. Alternatively, if there is a problem associated with a simulation, the same problem can be identified in related (either parent or child) simulations before they cause damage to the industrial process.

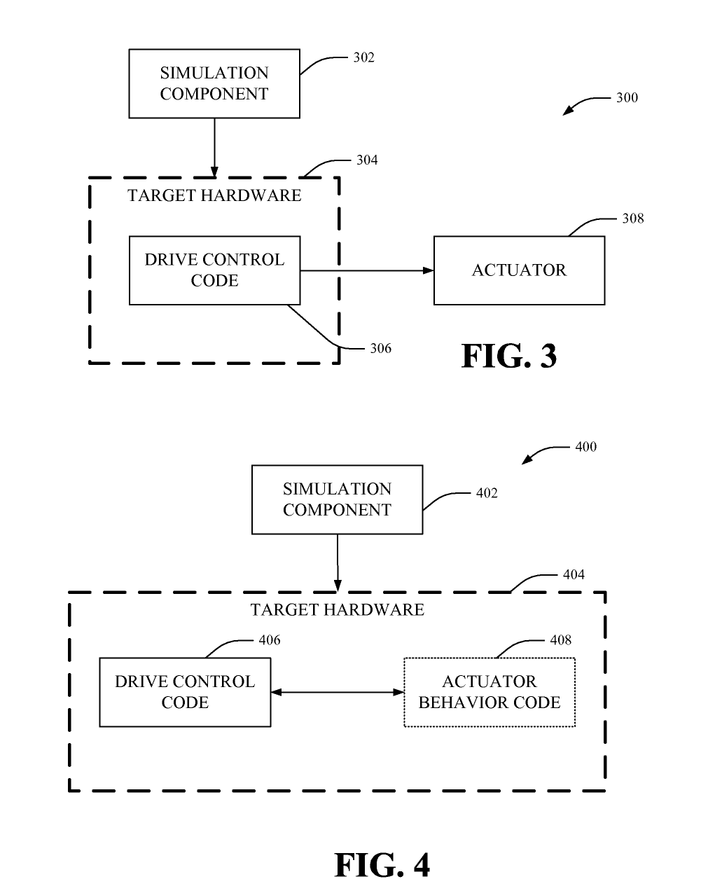

FIG. 3 depicts a system 300 according to an aspect of the subject innovation relating to how a simulation and generated code can be employed within target hardware. Simulation component 302, as described above with respect to FIGS. 1 and 2 can comprise a commercial computing package, or any other component (hardware, or software, or combination thereof) capable of producing a simulation. The simulation generally represents some target hardware 304, which can comprise any piece of hardware, software, or combination thereof, or other equipment or machinery. The target hardware 304, or a subset of components thereof, can be controlled by the drive control code 306 produced, at least in part, by the simulation component 302. At least a sub-set of the target hardware can be simulated by the simulation, the drive control code produced from the simulation, or any combination thereof. Additionally, real (as opposed to simulated) components such as actuator 308 can be controlled by the drive control code 306 within the target hardware 304.

FIG. 4 depicts a system 400 in relation to an aspect of the subject innovation illustrating an implementation of a simulation. Simulation component 402 can produce a simulation representing target hardware 404, which can comprise any element or component of an industrial operation that can be simulated. The simulation can include drive control code 406 that can control at least a portion of the target hardware 404. The drive control code 406 can be created by the simulation component 402 to include actuator behavior code 408, that can be code for controlling a simulated component, such as an actuator. FIGS. 3 and 4 are intended, in part, to depict the versatility of the subject innovation—depending on the circumstances the simulation can include all, or some sub-components of a given industrial application. A gifted designer can judiciously select between simulated and real components in order to create, test, and optimize an industrial operation.

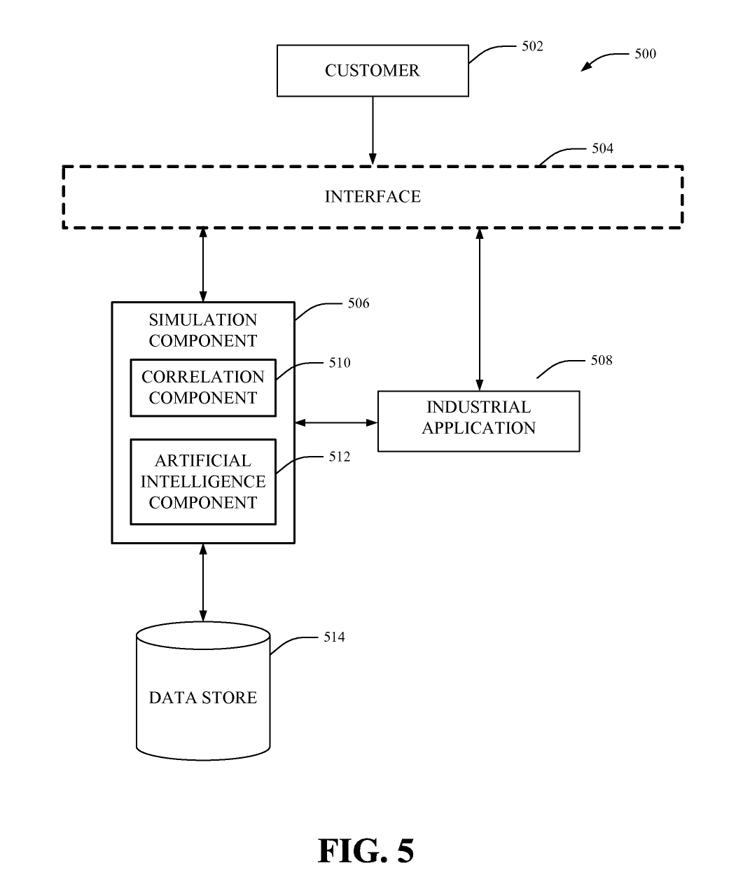

Proceeding now to FIG. 5, an industrial design and diagnosis system 500 is illustrated. Customer 502 represents any individual or entity interested in purchasing, renting, or otherwise implementing industrial equipment in an industrial process. The system 500 allows the customer 502 to select equipment for the industrial process in a more informed fashion than with conventional systems. Interface 504 comprises the mechanism for allowing the customer 502 to submit and receive information relating to the system 500, and can comprise a graphical user interface, a command line interface, or any other suitable interface in accordance with the subject disclosure. System 500 can be deployed over a networked environment such as a wide area network (WAN) a local area network (LAN) or on a larger scale such as the internet, and can comprise a web-based interaction system accessible via a web browser.

Simulation component 506 can perform as described elsewhere herein. In accordance with one embodiment, simulation component 506 can receive a specification for an industrial application 508 from the customer 502 via the interface 504. The customer 502 can provide as many details of the desired application as deemed appropriate for a given situation. The specification can include information in a hierarchical form, where each element that contains sub-elements can be specified. Interface 504 can include the ability to receive the customer's 502 description of the industrial application 508 in a variety of formats and convert the information to a format suitable for the simulation component 506. (In one embodiment, simulation component 506 is a commercially available simulation package, which may or may not have a required input format for a simulation). Interface 504 can mitigate potential problems associated with less than optimal compatibility between the customer's 502 input and the simulation component 506.

In one embodiment, the customer may seek to design an industrial application 508 and has acquired several elements, but is still searching for other elements to be employed in connection with the industrial application 508. The customer 502 can specify which elements (if any) of the industrial application 508 are in his possession, and which elements have yet to be acquired and/or implemented. In this embodiment, the customer may seek to know whether a given piece of equipment will fail to meet expectations by overheating, or by mechanical failure, or by any other unsatisfactory results. In another embodiment, the customer 502 has some elements in place but has not yet explored options available to complete the industrial application, and can use the system 500 similar to a catalogue of industrial elements. Unlike conventional catalogues however, this catalogue can be interactive and intelligent and assist the customer 502 much the way a skilled technician would.

Once the industrial application 508 is specified to the customer's satisfaction, simulation component 506 can perform as described elsewhere herein. Correlation component 510 can convey a measure of accuracy (e.g., a correlation) with which the simulation represents the actual hardware, and can predict to the customer 502 results under given simulation situations and circumstances. In this manner, customer 502 can receive information regarding the industrial application 508 if constructed under the given conditions. Customer 502 can submit information describing the working conditions of the industrial application 508, and can include a predicted max-load or worst case scenario situation in order to simulate the most demanding or challenging circumstances in which the equipment can be expected to perform. The results can provide valuable insight into whether the customer 502 should purchase equipment, how to diagnose a problem, in addition, a list of possible solutions can be provided. For example, simulation component 506 can offer a choice of a number of elements (e.g., two or three different actuators made by competing companies) and display their operating information, price, availability, and the like. The customer 502 can then make an informed purchasing decision.

Artificial intelligence component 512 can additionally enhance the purchasing decision by storing past solutions in a data store 514, receiving the customer's 502 specification, and comparing the specification to past arrangements. If there is a past arrangement that is satisfactorily similar to the customer's 502 proposed industrial application 508, these options can be presented to the customer 502. The solution can also be simulated and perhaps modified to suit the customer's 502 needs according to artificial intelligence techniques as described above.

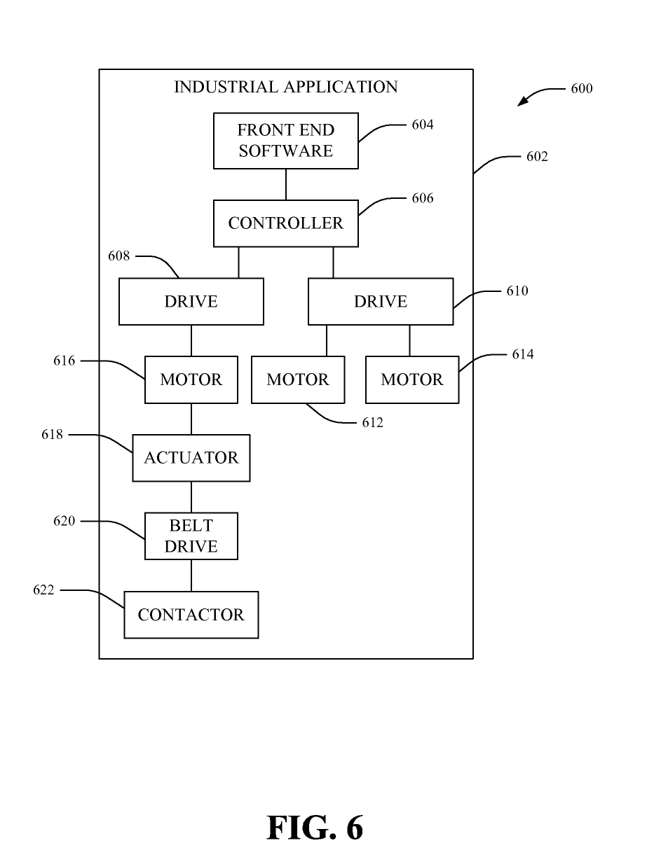

FIG. 6 depicts a system 600 for improving, designing, testing, or otherwise working with an industrial application 602 that can be typical for use with the subject innovation; however, the principles of the subject disclosure are not limited to the examples given in any way. Software elements such as the front end software 604 can be analyzed much in the same way that other elements are analyzed as described herein. In this example, a portion of the industrial application 602 has been specified as containing a controller 606, two drives 608 and 610 and other sub-elements. The control code for the example drive, and/or the simulation of the drive can be used to control the drive, either each alone (the control code alone, or the simulation alone) or in some combination. The subject disclosure allows inclusion of as much detail as desired, drilling down into the industrial application 602 as far as appropriate. As shown, drive 610 contains two motors 612 and 614, and no sub-elements are shown to depict that the customer is only concerned with motors 612 and 614 and is not concerned with the sub-elements. Simultaneously, drive 608 and its sub-elements such as motor 616, actuator 618, belt drive 620 and contactor 622 are of concern in this example. The concern can be focused on areas that have not yet been solidified in the design process, or have caused some trouble in a previous design. For example, suppose that industrial application 602 has been employed previously, but problems with contactor 622 have persisted. It may not be known exactly what causes the problem; it may be somewhere between drive 608 and contactor 622, so the system 600 can be employed to ferret out the source of the problem, and perhaps to identify alternative approaches. In another embodiment, a customer has specified which sub-elements of motors 612 and 614 are to be used, but has not done so with motor 616, and therefore wishes to identify elements that will provide desirable characteristics in the context of the industrial application 602. Moreover, industrial application 602 may be only a small portion of the overall process, and the customer either does not know the remainder of the elements, or they have already been decided and are therefore out of the scope of the endeavor for the moment. There are a variety of reasons a customer may specify some information and withhold other information, not all of which can be described here; the preceding is given for illustrative purposes only.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of machine learning, or knowledge or rule based components, sub-components, processes, means, methodologies, or mechanisms (e.g. support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

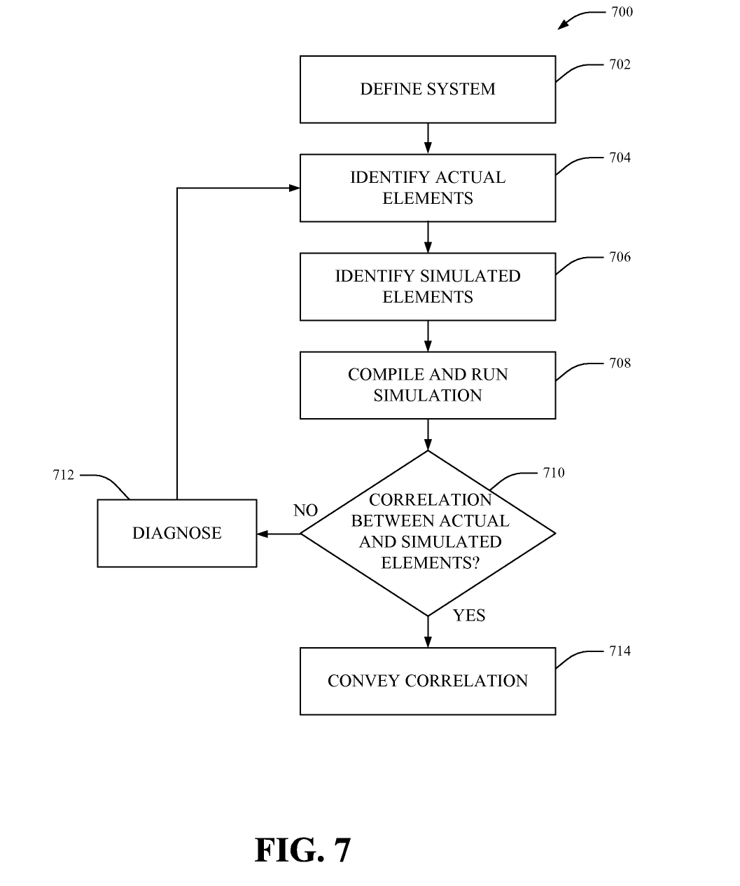

In view of the illustrative systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 7 shows a methodology 700 for designing an industrial application including the use of a simulation that represents hardware and/or software elements of the industrial application. At reference numeral 702, the specifics of the industrial application are specified, which can be any type of automated process involving an element that can be simulated, including but not limited to a conveyor system, an assembly line, a bottling operation, or a manufacturing process. Specification of the industrial process can be performed by a human operator, entering information to a computer terminal or other interface, or it can be read in from a machine over a network or other means of communication. The specifics can contain sufficient details of the industrial process to enable simulation thereof, and can comprise an entire stand-alone application, or a sub-set of a larger application. At reference numeral 704, elements that exist in the real world and are readily available are identified. The industrial application may comprise both actual elements, and elements that are for some reason unavailable for immediate access, but are nevertheless planned to form part of the industrial application at some point. An example is an element that has not yet been delivered or manufactured, but is scheduled for delivery upon which it will participate in the industrial application. Another example is if the user is choosing between a plurality of elements from competing manufacturers, and desires to simulate the performance of each in order to make an informed purchase decision. Many actual elements are capable of interacting with a simulation much in the same way a simulated representation of that element would, in which case the actual element can participate in the simulation of the industrial application, and thus eliminate the need to simulate that element. For example, many electro-magnetic motors are capable of communicating their operation to a computer terminal. This type of motor can be placed in communication with a simulated environment and participate in the simulation.

At reference numeral 706 the remainder of the elements are identified, and simulations representing these elements are generated or otherwise obtained. Frequently hardware is used in more than a single application, so it is likely that a simulation for a given element or arrangement of elements exists in memory and there is no need to generate a new simulation. In addition, some hardware is substantially similar but not exactly the same as other hardware, in which case the similarities can be analyzed and if they are determined to be of little consequence, a simulation representing a slightly different version of the hardware can be used. The elements identified at reference numerals 704 and 706 can comprise an entire simulation, however, the simulation can comprise a small sub-set of a larger operation.

Reference numeral 708 describes the compilation and running of the simulated elements. The simulation can include a variety of test situations in which the elements are expected to operate, including some challenging situations (such as a dirty environment, high temperature operation, maximum loads, etc.) in order to explore the limits of the elements' capabilities and their resilience to such conditions. These operating conditions can mirror actual operating conditions under which the actual elements have run previously, and the operation of the actual elements under such conditions can be stored. At reference numeral 710, the simulated elements or arrangement of elements can be compared to the actual performance. In one embodiment this comparison can be used to ensure the quality of the simulation, in terms of how well the simulation represents the actual operation of the elements. The correlation between simulation and actual can be reported in varying degrees of correlation. Correlation can be measured in a plurality of ways and each can be useful to a designer depending on the particulars of the application. For example, if heat levels in a given motor are of concern, the thermal behavior of an element and other characteristics that affect thermal variables (such as friction, lubrication, etc) can be more important than other characteristics. Therefore, if the simulation accurately represents the element's ability to manage heat loads and other thermal inputs, the simulation can be said to correlate with the element despite a lesser correlation of other characteristics. Stated in other terms, correlation can be a function of user preferences, device context, and many other variables. For purposes of simplification, at reference numeral 710 the correlation, however defined, is evaluated.

If no satisfactory correlation is reached, at reference numeral 712 the user can be prompted to diagnose the situation. Information regarding the correlative failure and the differences between the actual and simulated elements can be fed back to the user for further modification. The methodology 700 can repeat this process until a correlation is obtained, as shown at reference numeral 714.

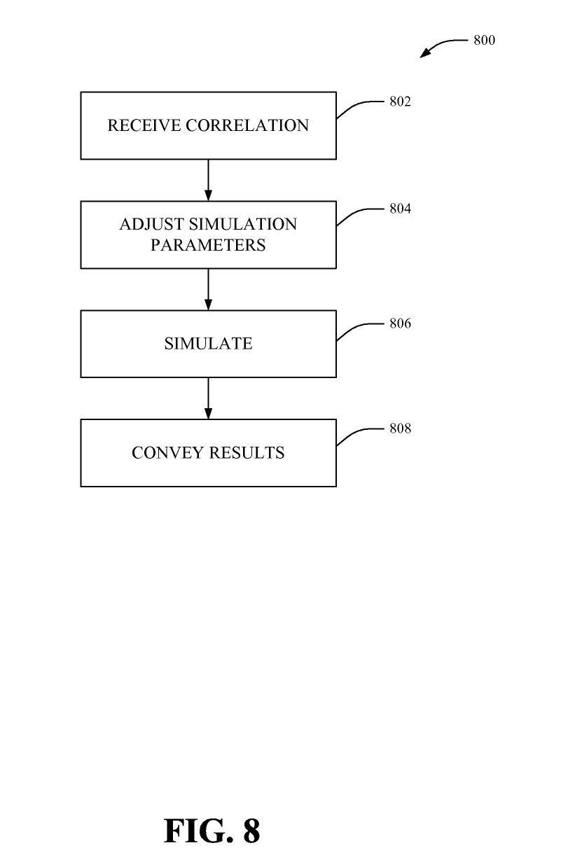

FIG. 8 shows a methodology 800 for designing an industrial application based at least in part upon simulated representations of actual hardware. At reference numeral 802, a correlation between simulated elements and actual hardware is received. The correlation can be obtained according to the methodology described with reference to FIG. 7, and can refer to individual elements or elements in an arrangement. With an assurance that hardware elements are represented by a simulation to a satisfactory degree allows a designer to freely create new arrangements. The designer can be creative and adventuresome with a design because the cost of testing such new solutions is much less than with conventional systems where a large investment is required to create an actual system. Troubleshooting is another context where the methodology 800 can prove beneficial. If there is a troublesome spot in the actual hardware of an existing system, the designer can manipulate simulated elements until a desirable result is reached, and then employ the same instructions in the actual hardware. For example, if a contactor in an application takes 60 milliseconds to open where it should only be taking 30 milliseconds, the designer can replicate the situation and troubleshoot much more efficiently in the simulation environment than by using actual hardware.

At reference numeral 804, a designer can adjust parameters of the simulation and explore various operating conditions. The designer can perturbate certain variables to simulate the difficult and sometimes unexpected environment in which the industrial application is to run. Unexpected events such as an upstream failure, or a loss of electrical power or the like can be simulated at reference numeral 806, and the results of the simulation can be conveyed to the designer 808. In this manner, the designer can put the simulated version of the industrial application through its paces and obtain an idea of how well (or how poorly) the equipment can perform.

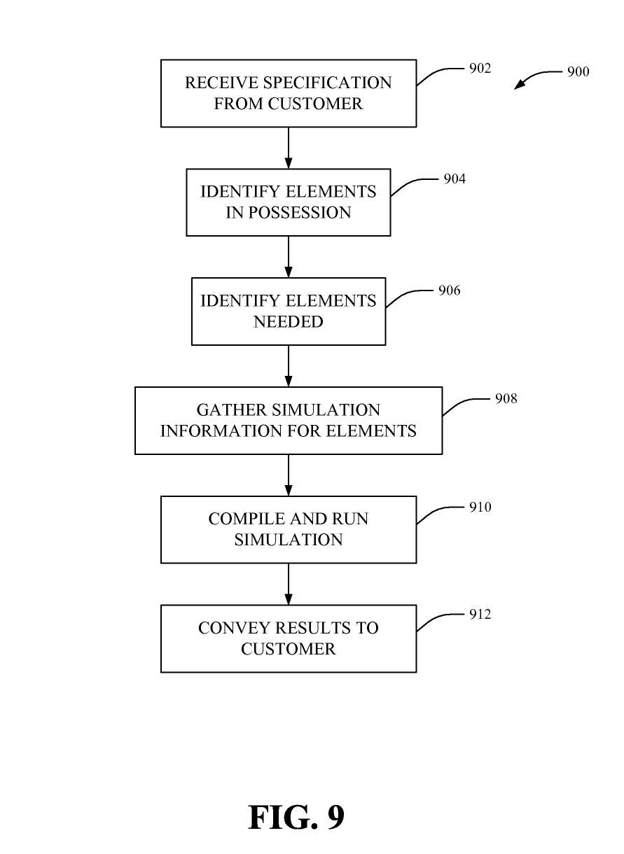

FIG. 9 depicts a methodology 900 for assisting a customer with an industrial design. At reference numeral 902, the customer provides a specification for an industrial process or part of the process. In an embodiment, the customer is desirous to purchase or otherwise acquire hardware to create the proposed industrial application, and may have an unclear idea of the options available. In another embodiment, the customer has identified specific hardware and seeks to test the operability of the hardware, and perhaps also in conjunction with other hardware and software elements that are part of the customer's application. The specification can be provided in a variety of ways. The customer can describe the application over the telephone to an operator who then enters the information, the customer can interact with a web-based interface and enter the information directly, or any other suitable means of communicating the description of the industrial process. At reference numeral 904, elements of the application that are in the customer's possession, if any, can be identified. The customer may be searching for a few elements to supplement the industrial process, and can be interested in testing the functionality of these elements in connection with other, untested elements in an effort to make an informed purchase decision. At reference numeral 906, such elements are identified. If the customer has an idea of which elements should be included, the customer can so indicate. Alternatively, the customer can request equipment suggestions or indicate a plurality of options which should be tested with the existing elements. Once the elements, both actual and simulated, are identified, at reference numeral 908 simulation information about the elements is gathered. This information can be stored in a data store for retrieval and use in a simulation, and can comprise simulations performed previously on similar elements to alleviate duplicative efforts. This simulation information can include a degree of correlation between the actual hardware and the simulative counterpart, as described above. At reference numeral 910, the simulation can be compiled and run, the output of which can be conveyed to the customer at reference numeral 912. The simulation can be created to represent as much detail as the customer desires, and therefore can provide detailed information about the operation of the selected elements which can inform the customer as to a purchasing or diagnostic decision. Further, the simulation can include an emphasis on certain elements that the customer is concerned with while perhaps placing less importance on other characteristics or aspects of the simulation. By way of example, if the customer's application requires exceedingly clean operation, emphasis can be placed on the elements' output such as gas or fluid emissions. Alternatively, if thermal capacity is important to the customer, then the thermal characteristics can be emphasized. This approach allows the customer to receive information that is most important to his operation, and prevents the customer from being overwhelmed with information that is of lesser value.

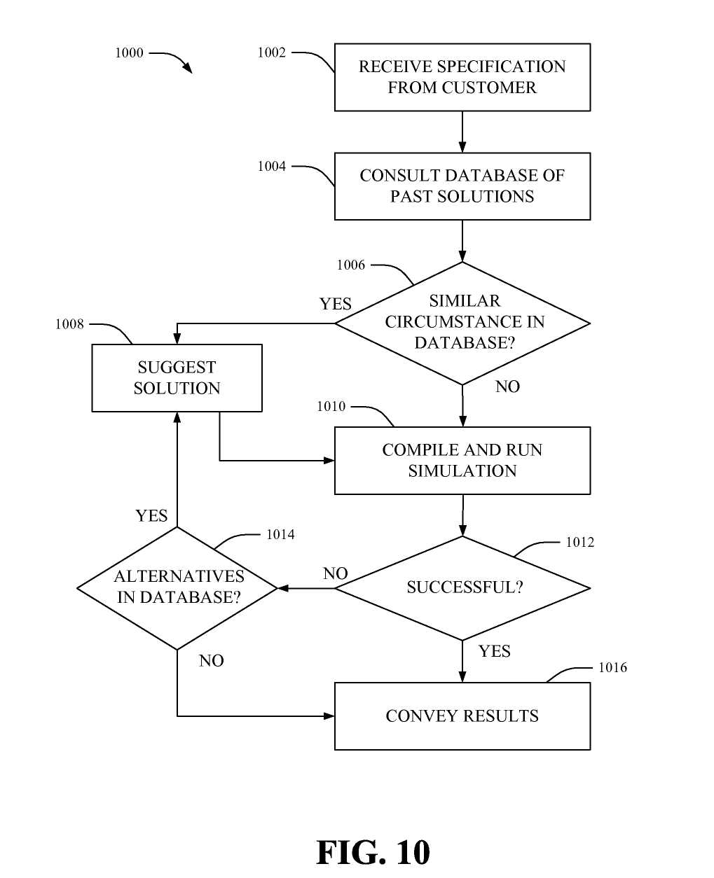

FIG. 10 renders a methodology 1000 that provides a customer with assistance with designing an industrial application. Methodology 1000 can operate in a similar situation as described with reference to FIG. 9 and methodology 900. At reference numeral 1002, the customer can specify details of the desired industrial application, which can include some elements in possession and some that have yet to be tested or are otherwise unproven. At reference numeral 1004, a database of past solutions can be consulted, containing previous configurations of industrial applications. At reference numeral 1006, the current industrial application and elements thereof can be compared to past solutions, and if a similar configuration is contained in the database, at reference numeral 1008 a suggestion can be made to the customer. Similarity between past solutions and present configurations can be judged on the basis of characteristics of the problem to be solved, the equipment used, the product in question, or any other relevant variable. As an example, if a customer seeks to create an application for transferring glass bottles from one location to another, the database may contain a past simulation in which glass bottles were handled successfully. Because of the relatively fragile nature of glass, the customer may wish to know which hardware and software configurations have been used successfully in the past to handle fragile materials such as glass. Some conveyor equipment can be more gentle than others, and this insight can prove valuable to the customer. In addition, the similarity can be assessed using the artificial intelligence techniques as discussed above. An artificial intelligence system can be used to infer similarity or dissimilarity between the customer's proposed configuration and the past solutions contained in the database.

At reference numeral 1010, the simulation can be compiled and run; and at reference numeral 1012 the success of the simulation can be measured. Success can depend on many factors, at least some of which can be indicated ahead of time by the customer. In the example given above of the glass bottles, the customer can specify that success means that fewer than a given percentage of the bottles are broken during the process. Any measure can be used evaluate the success of the simulated process. If success is not obtained, at reference numeral 1014 alternative solutions can be sought from the database, and new suggestions can be made at reference numeral 1008, and a new simulation compiled and run. This loop can continue until success is reached, or no viable alternatives exist in the database, at which point the results can be conveyed back to the customer at reference numeral 816.

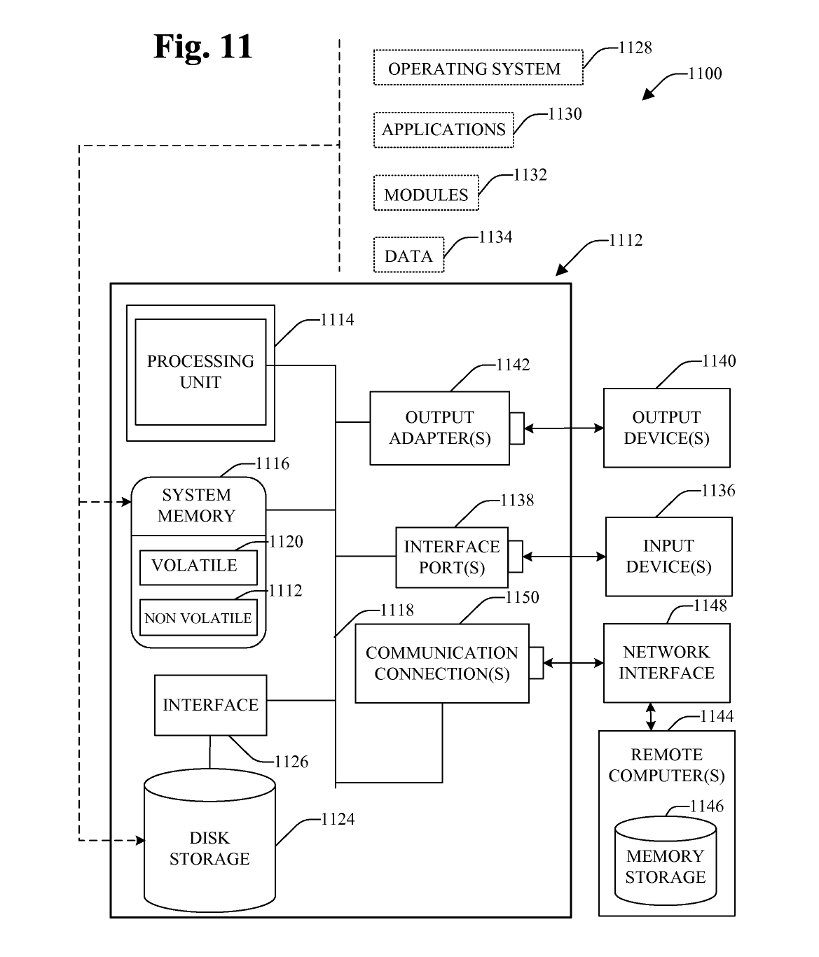

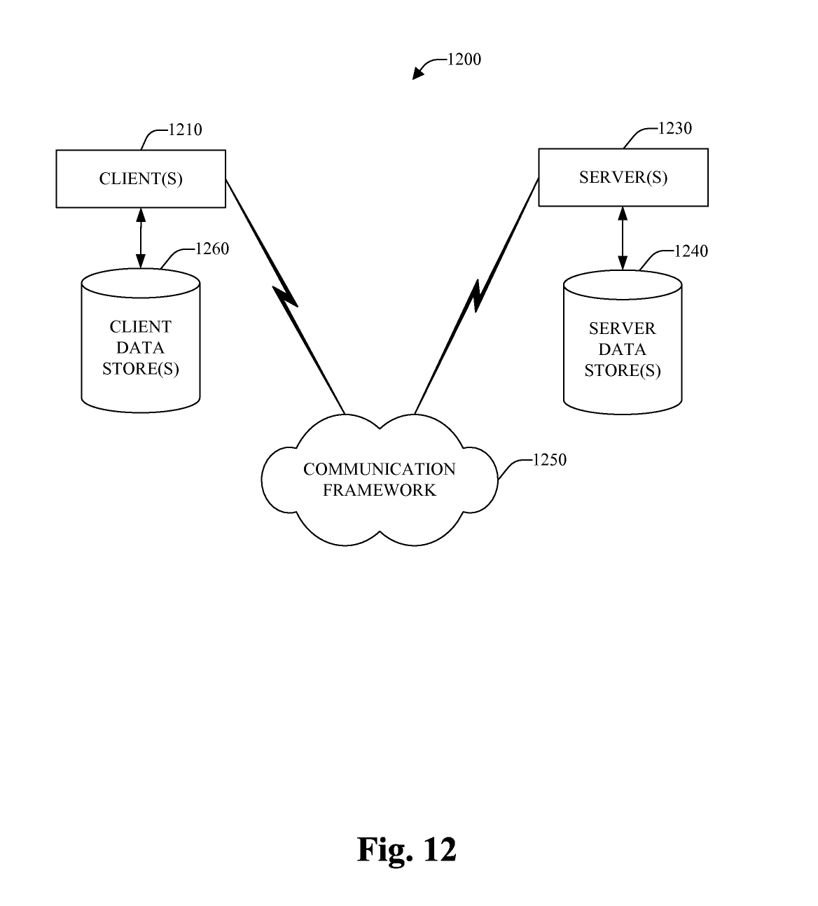

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 11, an exemplary environment 1100 for implementing various aspects disclosed herein includes a computer 1112 (e.g., desktop, laptop, server, hand held, programmable consumer or industrial electronics . . . ). Additionally, computer 1112 can comprise an actual target hardware system, and can comprise an embedded computer that has all the characteristics of environment 1100. The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates, for example, disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the present invention can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112 and to output information from computer 1112 to an output device 1140. Output adapter 1142 is provided to illustrate that there are some output devices 1140 like displays (e.g., flat panel and CRT), speakers, and printers, among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems, power modems and DSL modems, ISDN adapters, and Ethernet cards or components.

FIG. 12 is a schematic block diagram of a sample-computing environment 1200 with which the present invention can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the present invention, for example. One possible communication between a client 1210 and a server 1230 may be in the form of a data packet adapted to be transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. An industrial application design system, comprising:
a simulation component that can represent operation of actual hardware elements used in the industrial application; and
a correlation component that can evaluate the degree of correlation that corresponds to the accuracy with which the simulation component represents operation of the actual hardware elements.

2. The system of claim 1, further comprising a code generation component that can receive a simulation from the simulation component and generate code from the simulation.

3. The system of claim 1, the simulation component comprises a commercially available computing package.

4. The system of claim 1, the correlation component reports the degree of correlation as a percentage.

5. The system of claim 1, the simulation is a composite simulation, containing at least one simulated element and at least one actual hardware element.

6. The system of claim 1, further comprising an artificial intelligence component that assists the correlation component in evaluating the degree of correlation.

7. The system of claim 1, the simulation component can receive a description of the industrial application from a customer, and can provide the customer with an evaluation of the performance of the simulation.

8. The system of claim 7, further comprising an artificial intelligence component that suggests alterations to the industrial application based, at least in part, upon completed simulations.

9. A method for designing an industrial application, comprising:
receiving a description of the industrial application;
identifying elements in possession;
identifying supplementary elements that are to be simulated;
compiling simulation information for the elements;
evaluating a correlation between the simulation information and the elements represented by the simulation;
performing a simulation based on the simulation information; and
conveying the results of the simulation.

10. The method of claim 9, further comprising reporting a measure of reliability of the simulation based, at least in part, upon the correlation.

11. The method of claim 9, the elements comprise at least one of hardware or software elements.

12. The method of claim 9, further comprising analyzing the description of the industrial application and comparing the description with past simulations.

13. The method of claim 12, further comprising suggesting elements for use in the industrial application.

14. The method of claim 12, further comprising performing the simulation including simulation information used in at least one past simulation.

15. The method of claim 9, the description of the industrial application is received from a customer.

16. The method of claim 9, further comprising employing a commercially available computing product to perform the simulation.

17. The method of claim 9, further comprising performing the simulation using a plurality of interchangeable supplementary elements.

18. The method of claim 17, further comprising reporting results from the simulations performed with the plurality of supplementary elements, and reporting the results for comparison.

19. A system for diagnosing an industrial application, comprising:
means for describing an industrial application, including elements in possession and supplementary elements;
means for evaluating a correlation between actual elements of the industrial application and simulative representations thereof;
means for performing a simulation of the industrial application;
means for reporting simulation results for diagnostic use.

20. The system of claim 19, further comprising means to evaluate a reliability of the simulation based, at least in part, upon an evaluation of the correlation.
